(19) United States
(12) Patent Application Publication
(10) Pub. No.: US 2006/0190162 A1
(43) Pub. Date: Aug. 24, 2006

(54) System and method for receiving vehicle data at a telematics unit over a short-range wireless connection

(75) Inventors: Nathan D. Ampunan, Novi, MI (US); Sylvia C. Karmanoff, Royal Oak, MI (US); Steven J. Ross, Livonia, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 11/062,404

(22) Filed: Feb. 22, 2005

(51) Int. Cl. G06F 7/00

(52) U.S. Cl. 701/117; 701/2

(57) ABSTRACT

A method of testing vehicle functions in a vehicle. The method includes receiving data from at least one sensor at a telematics unit of the vehicle via a short-range wireless connection and sending the received data from the telematics unit to an engineering monitoring station via a wireless connection.

### FIELD OF THE INVENTION

This invention relates generally to collecting data from a vehicle via a short-range wireless connection. In particular, the invention relates to receiving vehicle data from at least one sensor at a telematics unit and sending the data to an engineering monitoring station.

### BACKGROUND OF THE INVENTION

When vehicles are in the pre-production development stage, test vehicles are outfitted with sensors at various locations in or on the vehicle. A black box located in the test vehicle is hardwired to the sensors and the sensor data is collected and stored in the black box. The sensors collect data while the test vehicles are driven in various locations, including race tracks, to test the vehicle in different types of driving conditions. After the test drives are complete, vehicle development engineers retrieve the black box and analyze the data stored in the black box.

The sensors must be placed in locations that do not cause the wires connected to the black box to twist or to break when the vehicle is driven. Some locations, from which sensor data would be valuable, cannot be used in test drives because the wires connected to the black box would be broken.

The black box has a limited I/O access, which limits the number of sensors that can collect data at any one time. Typically the I/O access is limited to less than 50 sensors. If more sensors could be placed on the test vehicle , more data would be collected for a given test drive. In that case, the number of test drives required for each test vehicle could be decreased and the quality of the analysis can be increased.

Some post-production vehicles develop intermittent problems. The diagnostic technicians at a vehicle service center have trouble diagnosing intermittent problems, if the problem does not occur when the diagnostic technicians test drive the vehicle. All the troubleshooting is then limited to the description of the problem provided by the vehicle user. In many cases, the user brings the vehicle to the vehicle service center many times, to try to resolve the problem. The sensors and black box used during the vehicle pre-production development stage can provide the data needed by the diagnostic technicians to resolve the intermittent problem, but it is costly and difficult to attach sensors to a vehicle and wire them to the black box to collect data relevant to the intermittent problem. Also, if the vehicle service center were to use the sensors and black box, the data would be collected continuously and the data storage in the black box could be filled before the intermittent problem occurs again.

Telematics units in vehicles can receive wireless transmissions of data, store the received data and transmit the received data to external storage.

It is desirable, therefore, to offer vehicle development engineers and diagnostic technicians at vehicle service centers a method of testing vehicle functions using telematics units that overcomes these and other disadvantages.

### SUMMARY OF THE INVENTION

One aspect of the present invention provides a method of testing vehicle functions in a vehicle. The method includes receiving data from at least one sensor at a telematics unit of the vehicle via a short-range wireless connection and sending the received data from the telematics unit to an engineering monitoring station via a wireless connection.

Another aspect of the present invention provides a system for testing vehicle functions in a vehicle. The system includes means for receiving data from at least one sensor at a telematics unit of the vehicle via a short-range wireless connection and means for sending the received data from the telematics unit to an engineering monitoring station via a wireless connection.

A third aspect of the present invention provides computer readable medium storing a computer program including computer readable code operable for receiving data from at least one sensor at a telematics unit of the vehicle via a short-range wireless connection and for sending the received data from the telematics unit to an engineering monitoring station via a wireless connection.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

Various embodiments of the present invention are illustrated by the accompanying figures, wherein:

FIG. 1 is a schematic diagram of a system for providing access to a telematics system in a mobile vehicle;

FIG. 2 illustrates a flowchart representative of a method of sending vehicle data to engineering monitoring station in accordance with the present invention;

FIG. 3 illustrates a flowchart representative of a first embodiment of a method of sending vehicle data in accordance with the present invention;

FIG. 4 illustrates a flowchart representative of a second embodiment of a method of sending vehicle data in accordance with the present invention;

FIG. 5 illustrates a flowchart representative of a third embodiment of a method of sending vehicle data in accordance with the present invention; and

FIG. 6 illustrates a flowchart representative of a method of requesting vehicle data in accordance with the present invention.

### DETAILED DESCRIPTION OF THE

### PRESENTLY PREFERRED EMBODIMENTS

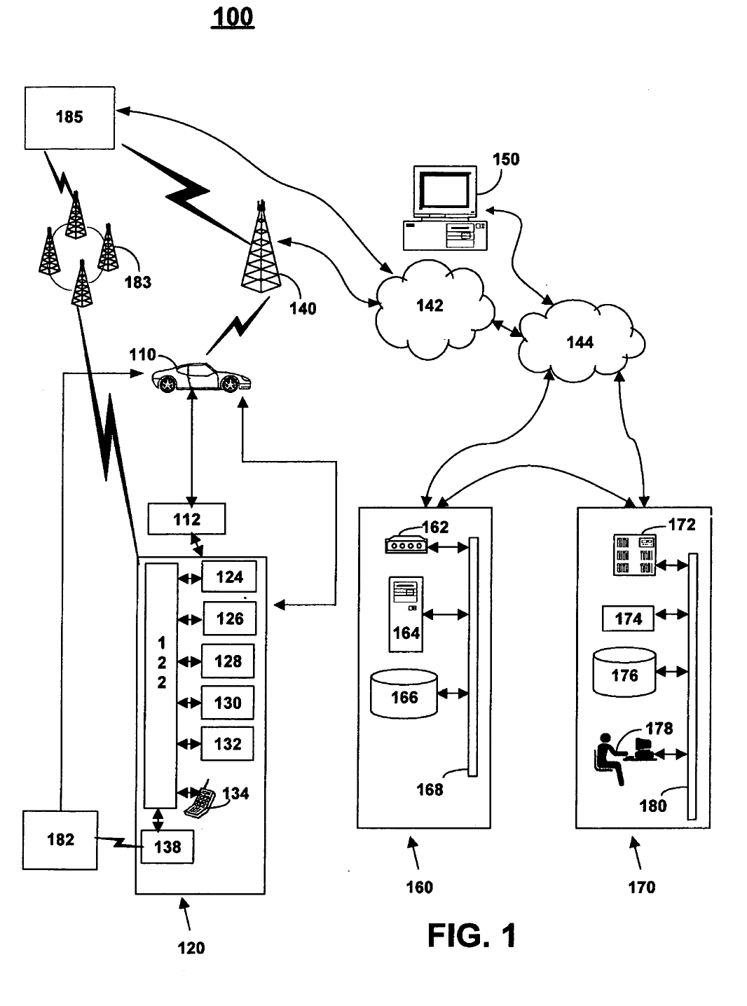

FIG. 1 illustrates one embodiment of system for data transmission over a wireless communication system, in accordance with the present invention at 100. Mobile vehicle communication system (MVCS) 100 includes a mobile vehicle communication unit (MVCU) 110, a vehicle communication network 112, a telematics unit 120, one or more wireless carrier systems 140, one or more communication networks 142, one or more land networks 144, one or more client, personal or user computers 150, one or more web-hosting portals 160, and/or one or more call centers 170. In one embodiment, MVCU 110 is implemented as a mobile vehicle equipped with suitable hardware and software for transmitting and receiving voice and data communications. During MVCU 110 development and testing, one or more wireless vehicle sensors 182 are located within or on the MVCU 110 to provide real-time data about the MVCU 110 conditions during various tests. MVCS 100 may include additional components not relevant to the present discussion. Mobile vehicle communication systems and telematics units are known in the art.

MVCU 110 may also be referred to as a mobile vehicle throughout the discussion below. MVCU 110 refers to a vehicle in which vehicle functions are tested. In operation, MVCU 110 may be implemented as a motor vehicle, a marine vehicle, or as an aircraft. MVCU 110 may include additional components not relevant to the present discussion.

MVCU 110, via a vehicle communication network 112, sends signals to various units of equipment and systems (detailed below) within MVCU 110 to perform various functions such as unlocking a door, opening the trunk, setting personal comfort settings, and calling from telematics unit 120. In facilitating interactions among the various communication and electronic modules, vehicle communication network 112 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications.

MVCU 110, via telematics unit 120, sends and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (GPS) unit 126, an in-vehicle memory 128, a microphone 130, one or more speakers 132, an embedded or in-vehicle mobile phone 134, and a short-range wireless device 138. In other embodiments, telematics unit 120 may be implemented without one or more of the above listed components, such as, for example GPS unit 126 or speakers 132. Telematics unit 120 may include additional components not relevant to the present discussion.

In one embodiment, processor 122 is a digital signal processor (DSP). Processor 122 is implemented as a microcontroller, microprocessor, controller, host processor, or vehicle communications processor. In an example, processor 122 is implemented as an application specific integrated circuit (ASIC). In another embodiment, processor 122 is implemented as a processor working in conjunction with a central processing unit (CPU) performing the function of a general purpose processor. GPS unit 126 provides longitude and latitude coordinates of the vehicle responsive to a GPS broadcast signal received from one or more GPS satellite broadcast systems (not shown). In-vehicle mobile phone 134 is a cellular-type phone, such as, for example an analog, digital, dual-mode, dual-band, multi-mode or multi-band cellular phone.

Processor 122 executes various computer programs that control programming and operational modes of electronic and mechanical systems within MVCU 110. Processor 122 controls communications (e.g. call signals) between telematics unit 120, wireless carrier system 140, and call center 170. In one embodiment, a voice-recognition application is installed in processor 122 that can translate human voice input through microphone 130 to digital signals. Processor 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers. In one embodiment, signals from processor 122 are translated into voice messages and sent out through speaker 132.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Wireless local area network 183 connects to an engineering monitoring station 185. In one embodiment, wireless local area network 183 is located within a short-range wireless distance from a test track for evaluating vehicles in the pre-production development stage. Engineering monitoring station 185 connects with wireless carrier system 140.

Client, personal or user computer 150 includes a computer usable medium to execute Internet browser and Internet-access computer programs for sending and receiving data over land network 144 and optionally, wired or wireless communication networks 142 to web-hosting portal 160. Personal or client computer 150 sends user preferences to web-hosting portal through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110. In operation, a client utilizes computer 150 to initiate setting or re-setting of user-preferences for MVCU 110. User-preference data from client-side software is transmitted to server-side software of web-hosting portal 160. User-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and from modem 162, data that is then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations and theft alarm settings. For each client, the web server potentially stores hundreds of preferences for wireless vehicle communication, networking, maintenance and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one embodiment, the call center 170 is a telematics call center, facilitating communications to and from telematics unit 120 in MVCU 110. In an example, the call center 170 is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network-systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services, including enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and land network 144. Communication services manager 174 transmits user-preference and other data to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 may provide requested information to communication services advisor 178.

In one embodiment, communication services advisor 178 is implemented as a real advisor. In an example, a real advisor is a human being in verbal communication with a user or subscriber (e.g. a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicate with telematics unit 120 in MVCU 110 through wireless carrier system 140, communication network 142, and/or land network 144 using voice transmissions, or through communication services manager 174 and switch 172 using data transmissions. Switch 172 selects between voice transmissions and data transmissions.

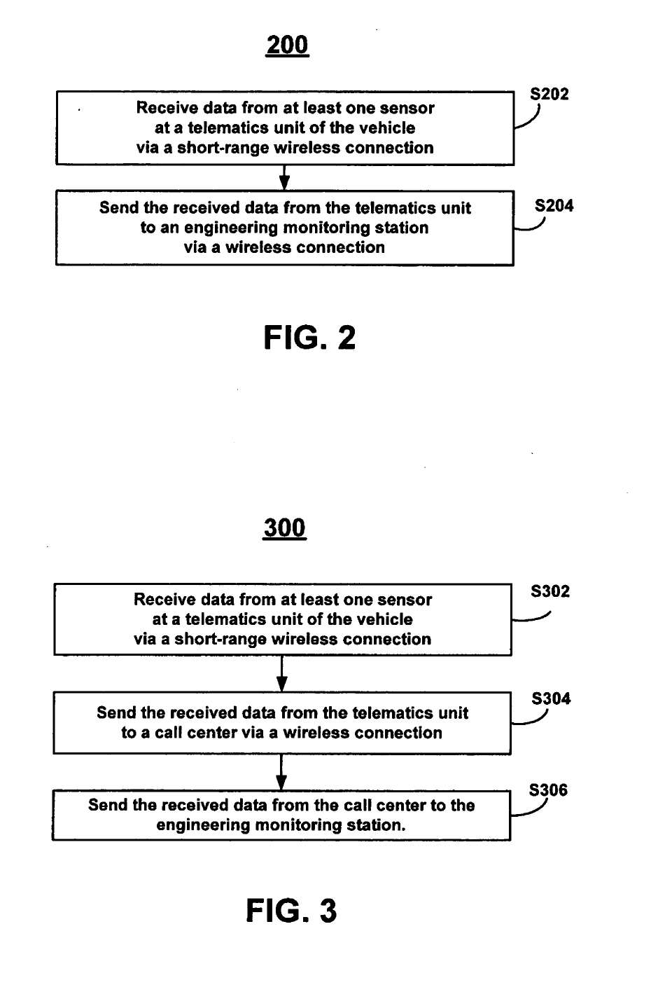

FIG. 2 illustrates a flowchart representative of a method 200 of sending vehicle data to an engineering monitoring station to test the vehicle functions within an MVCU 110, in accordance with the present invention. In one embodiment, the MVCU 110 is a test vehicle in a pre-production development stage. In another embodiment, the MVCU 110 is a vehicle in a post-production stage that has developed an intermittent problem, which diagnostic technicians in a vehicle service center are unable to resolve.

During stage S202, the telematics unit 120 in the MVCU 110 receives data from at least one of the wireless vehicle sensors 182 via a short-range wireless connection. The wireless vehicle sensors 182 each include a wireless transceiver capable of receiving and transmitting short-range wireless signals. In one embodiment, the wireless vehicle sensors 182 send data to the telematics unit 120 as the data is collected at the wireless vehicle sensors 182 without storing the data. In another embodiment, the wireless vehicle sensors 182 include a memory (not shown) to store data. In this embodiment, the wireless vehicle sensors 182 collect and store data and then send the stored data to the telematics unit 120 after a preset amount of data has been stored or a preset amount of time has elapsed. Each wireless vehicle sensor 182 includes a processor (not shown) to control the sampling frequency of the wireless vehicle sensor 182, to control the data transmission and to control data storage within the wireless vehicle sensor 182. The wireless vehicle sensors 182 include, but are not limited to, humidity sensors, temperature sensors, torque sensors, accelerometers, pressure sensors, vibration sensors and gyroscopes operating within or on the MVCU 110.

The MVCU 110 includes a telematics unit 120 configured with a short-range wireless device 138. The short-range wireless device 138 can be a Bluetooth chip, a Wi-Fi chip, a FCC Part 15 device or a radio chip. The data from at least one wireless vehicle sensor 182 is received at the short-range wireless device 138, which includes a wireless transceiver capable of receiving and transmitting short-range wireless signals. The short-range wireless device 138 can include a processor. In one embodiment, the short-range wireless device 138 is internal to the processor 122 in the telematics unit 120.

In one embodiment, the short-range wireless device 138 can receive data from one hundred (100) wireless vehicle sensors 182. The number of wireless vehicle sensors 182, with which the short-range wireless device 138 can interface, is related to the sampling frequency of the wireless vehicle sensors 182 and the amount of on-board storage in the wireless vehicle sensors 182. In another embodiment, more than one hundred (100) wireless vehicle sensors 182 can send data to the short-range wireless device 138.

The short-range wireless device 138 and the wireless vehicle sensors 182 communicate via a compatible short-range wireless technology. If the wireless transceiver in the short-range wireless device 138 is a Bluetooth chip, a Wi-Fi chip, or a radio chip then the wireless transceivers in the wireless vehicle sensors 182 include Bluetooth chips, Wi-Fi chips, or radio chips, such as FCC Part 15 devices, respectively. The Bluetooth chip, Wi-Fi chip, FCC Part 15 device and radio chip can each provide a link between the telematics unit 120 and one or more wireless vehicle sensors 182 operating within or on the MVCU 110.

Bluetooth is a worldwide digital radio standard developed to allow devices to communicate wirelessly over short distances, typically less than 10 meters. A Bluetooth chip provides spectrum spreading by frequency hopping in seventy-nine (79) hops of 1 MHz, starting at 2.402 GHz and finishing at 2.480 GHz. The Bluetooth chip uses Gaussian Frequency Shift Keying (GFSK) where a binary one is represented by a positive frequency and a binary zero is represented by a negative frequency deviation.

Wi-Fi chips operate in the unlicensed 2.4 and 5 GHz radio bands at data rates of 11 Mbps or 54 Mbps, according the IEEE specifications 802.11a, 802.11b and 802.11g, respectively, or with both bands (dual band).

A radio chip can be a radio access chip, which operates in a 2G, 2.5G or a 3G wireless network to communicate with a radio network controller that interfaces with service nodes and gateways to mediate with the network service providers.

In one embodiment, the telematics unit 120 is configured to periodically request diagnostic information from the wireless vehicle sensors 182. In another embodiment, the wireless vehicle sensors 182 are configured to send diagnostic information to the telematics unit 120 either continuously or periodically.

The data is acquired during the testing phase of the development of the MVCU 110. In one embodiment, the data is acquired to troubleshoot an intermittent problem with an MVCU 110. In this case, a vehicle service center places wireless vehicle sensors 182 in the MVCU 110. When the user, who has purchased the MVCU 110, recognizes that the MVCU 110 is having the intermittent problem, the user turns on the short-range wireless device 138 to request and receive the data emitted by the wireless vehicle sensors 182. In another embodiment the short-range wireless device 138 may be turned on via a voice command from a speech processing module (not shown) that includes both speech annunciation and recognition functionality resident within the telematics unit 120, a speech processing module (not shown) that includes both speech annunciation and recognition capabilities resident at the call center 170, or turned on via the advisor 178 at the call center 179. In another embodiment, the short-range wireless device 138 may be turned on by the user via web portal 160.

During stage S204, the telematics unit 120 sends the data received from the wireless vehicle sensors 182 to an engineering monitoring station 185 via a wireless connection. In one embodiment, the engineering monitoring station 185 is a vehicle service center. The protocol for the transmission from the telematics unit 120 is stored in computer readable medium within at least one computer program. Based on the protocol, the telematics unit 120 inserts the address of the engineering monitoring station 185 into the header on the transmitted data packet to direct the data through the one or more wireless carrier systems 140, one or more communication networks 142, and/or one or more land networks 144 to the engineering monitoring station 185. Three transmission routing options for transmitting the vehicle data to the engineering monitoring station 185 are described in detail below in reference to methods 300-500 of FIGS. 3-5, respectively.

FIG. 3 illustrates a flowchart representative of a first embodiment of a method 300 of sending vehicle data in accordance with the present invention. The wireless vehicle sensors 182, the telematics unit 120 and the short-range wireless device 138 have stored in computer readable medium at least one computer program, which includes computer readable code to perform the operations described with reference to method 300.

Stage S302 is the same as stage S202 described above with reference to method 200 in FIG. 2. During stage S302, the telematics unit 120 in the test MVCU 110 receives data from at least one wireless vehicle sensor 182 via a short-range wireless connection. During stage S304, the telematics unit 120 sends the test data received from the wireless vehicle sensors 182 to the call center 170 via one or more wireless carrier systems 140, one or more communication networks 142, and/or one or more land networks 144. During stage S306, the call center 170 sends the data received from the telematics unit 120 to the engineering monitoring station 185 via one or more wireless carrier systems 140, one or more communication networks 142, and/or one or more land networks 144.

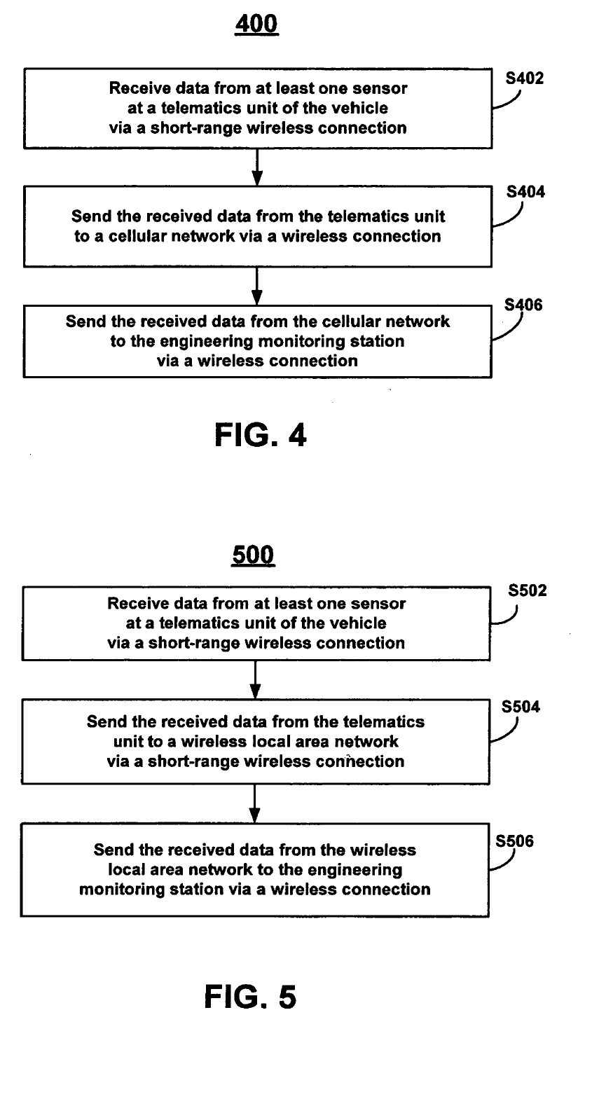

FIG. 4 illustrates a flowchart representative of a second embodiment of a method 400 of sending vehicle data in accordance with the present invention. The wireless vehicle sensors 182, the telematics unit 120 and the short-range wireless device 138 have stored in computer readable medium at least one computer program, which includes computer readable code to perform the operations described with reference to method 400.

Stage S402 is the same as stage S202 described above with reference to method 200 in FIG. 2. During stage S402, the telematics unit 120 in the MVCU 110 receives data from at least one wireless vehicle sensor 182 via a short-range wireless connection.

During stage S404, the telematics unit 120 sends the data received from the wireless vehicle sensors 182 to a cellular network, which includes one or more wireless carrier systems 140, via a wireless connection. The processor 122 in telematics unit 120 receives the data from short-range wireless device 138 and transmits it to the wireless modem 124 for transmission via the wireless carrier system 140.

During stage S406, the cellular network sends the received data to the engineering monitoring station 185 via a wireless connection. In one embodiment, the data is sent to the engineering monitoring station 185 via one or more wireless carrier systems 140, one or more communication networks 142, and/or one or more land networks 144.

FIG. 5 illustrates a flowchart representative of a third embodiment of a method 500 of sending vehicle data in accordance with the present invention. The wireless vehicle sensors 182, the telematics unit 120 and the short-range wireless device 138 have stored in computer readable medium at least one computer program, which includes computer readable code to perform the operations described with reference to method 500.

Stage S502 is the same as stage S202 described above with reference to method 200 in FIG. 2. During stage S502, the telematics unit 120 in the MVCU 110 receives data from at least one wireless vehicle sensor 182 via a short-range wireless connection.

During stage S504, the telematics unit 120 sends the data received from the wireless vehicle sensors 182 to a wireless local area network 183 via a short-range wireless connection.

The wireless local area network 183 can be a wireless local area network in, on or near the test track used in the development and final testing of MVCUs 100 before the start of vehicle production. The MVCU 110 is driven in laps around the test track while the wireless vehicle sensors 182 transmit data to the short-range wireless device 138 in the telematics unit 120. The processor 122 receives data from the short-range wireless device 138 and stores the data in the in-vehicle memory 128. When the MVCU 110 drives within the short-range wireless distance of a transceiver in the wireless local area network 183, the short-range wireless device 138 signals the processor 122 to retrieve the data stored the in-vehicle memory 128. Then the short-range wireless device 138 receives the retrieved data from the processor 122 and transmits the data to the closest transceiver in the wireless local area network 183 via a short-range wireless connection.

A processor (not shown) in the short-range wireless device 138 manages the transceiver functions. The telematics unit 120 continues to save the currently arriving data from the wireless vehicle sensors 182 in the in-vehicle memory 128 while previously received data is being transmitted to the wireless local area network 183. In one embodiment, the processor 122 manages the data flow so that currently arriving data overwrites the data in the in-vehicle memory 128 that was previously transmitted to the wireless local area network 183.

In one embodiment, the MVCU 110 is within the communication range with the wireless local area network 183 at all positions on the test track. In this embodiment, the wireless vehicle sensors 182 transmit data to the short-range wireless device 138 in the telematics unit 120 and the short-range wireless device 138 sends the received data to the wireless local area network 183 as the data is received via a short-range wireless connection.

In another embodiment, processor 122 receives the data from the short-range wireless device 138 and transmits it to the wireless modem 124 for transmission to the wireless local area network 183. In this embodiment, the wireless connection is not a short-range wireless connection.

During stage S506, the wireless local area network 183 transmits the data to the engineering monitoring station 185 via a wireless connection. In one embodiment, the wireless local area network is a short-range local area network and the data is sent to the engineering monitoring station 185 via a short-range wireless connection. The engineering monitoring station 185 processes the data emitted by the wireless vehicle sensors 182 to evaluate the quality of the MVCU 110 in operation under various conditions. In one embodiment, the engineering monitoring station 185 is included in one of the nodes of the wireless local area network 183.

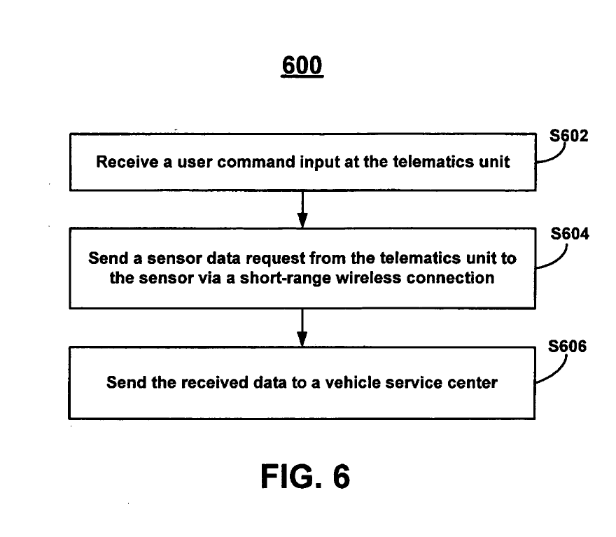

FIG. 6 illustrates a flowchart representative of a method 600 of requesting vehicle data in accordance with the present invention. The wireless vehicle sensors 182, the telematics unit 120 and the short-range wireless device 138 have stored in computer readable medium at least one computer program, which includes computer readable code to perform the operations described with reference to method 600. The process described for method 600 is useful in an application in which vehicle functions are tested in an MVCU 100 that was sold to a user. For example, data can be collected from a MVCU 100 and sent to an engineering monitoring station 185 in a vehicle service center to troubleshoot an intermittent vehicular problem. The data is collected only when the problem is occurring. In this embodiment, the wireless vehicle sensors 182 are attached to the MVCU 110 at the vehicle service center.

During stage S602, the telematics unit 120 receives a user command input. The user command input is operable to initiate the transmission of a sensor data request to the wireless vehicle sensors 182. The user command input can be a push of a button on the telematics unit 120 by the user.

During stage S604, the telematics unit 120 sends a sensor data request to the wireless vehicle sensors 182 via a short-range wireless connection in response to the user command input. The sensor data request is sent via a hard wire connection in the telematics unit 120 to the short-range wireless device 138, which sends the sensor data request via a short-range wireless connection. The sensor data request is received by the transceivers in the wireless vehicle sensors 182. The transceivers send the sensor data request to the processors in the wireless vehicle sensors 182, which then prompt the wireless vehicle sensors 182 to transmit sensed data via a short-range wireless connection to the short-range wireless device 138.

In one embodiment, the sensor data request is sent via a hard wire connection in the telematics unit 120 to the short-range wireless device 138 in order to prompt the short-range wireless device 138 to receive data from the wireless vehicle sensors 182 via a short-range wireless connection. In this embodiment, the wireless vehicle sensors 182 are continuously or periodically sending data, but the short-range wireless device 138 is not powered up to receive the data until the user command input is received at the telematics unit 120.

In another embodiment, the sensor data request is sent via a hard wire connection in the telematics unit 120 to the short-range wireless device 138 in order to prompt the transmission of data received by the short-range wireless device 138 from the wireless vehicle sensors 182 to an external site such as an engineering monitoring station 185 in a vehicle service center. In this embodiment, the wireless vehicle sensors 182 are continuously or periodically sending data and the short-range wireless device 138 is continuously or periodically receiving the data. However, before the user command input is received, the data is not stored in the in-vehicle memory 128 nor is it sent to the engineering monitoring station 185 of the vehicle service center.

During stage S606 the received data is sent to a vehicle service center to troubleshoot the intermittent problem with the MVCU 120. The vehicle service center contacts the user of the MVCU 110 once the received data has been used to isolate and troubleshoot the problem. Then the user takes the MVCU 110 to the vehicle service center for service and the removal of the wireless vehicle sensors 182.

While the embodiments, of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of testing vehicle functions in a vehicle, the method comprising:
receiving data from at least one sensor at a telematics unit of the vehicle via a short-range wireless connection; and
sending the received data from the telematics unit to an engineering monitoring station via a wireless connection.

2. The method of claim 1, further comprising:
receiving a user command input at the telematics unit; and
sending a sensor data request from the telematics unit to the sensor via a short-range wireless connection, wherein the received data is sent by the sensor responsive to the request.

3. The method of claim 2, wherein the engineering monitoring station includes a vehicle service center.

4. The method of claim 1, wherein the received data is sent from the telematics unit to a call center and from the call center to the engineering monitoring station via a wireless connection.

5. The method of claim 1, wherein the received data is sent from the telematics unit to a wireless local area network via a short-range wireless connection and from the wireless local area network to the engineering monitoring station via a wireless connection.

6. The method of claim 1, wherein the received data is sent from the telematics unit to a cellular network via a wireless connection and
from the cellular network to the engineering monitoring station via a wireless connection.

7. The method of claim 1, wherein a short-range wireless connection utilizes a Wi-Fi standard.

8. The method of claim 1, wherein a short-range wireless connection utilizes a Bluetooth standard.

9. The method of claim 1, wherein the at least one sensor comprises one or more sensors selected from the group consisting of humidity sensors, temperature sensors, torque sensors, accelerometers, pressure sensors, vibration sensors and gyroscopes.

10. A system for testing vehicle functions in a vehicle, the system comprising:
means for receiving data from at least one sensor at a telematics unit of the vehicle via a short-range wireless connection; and
means for sending the received data from the telematics unit to an engineering monitoring station via a wireless connection.

11. The system of claim 10, further comprising:
means for sending a user command input to the telematics unit; and
means for sending a sensor data request from the telematics unit to the sensor via a short-range wireless connection.

12. A computer readable medium storing a computer program comprising:
computer readable code for receiving data from at least one sensor at a telematics unit of the vehicle via a short-range wireless connection; and
computer readable code for sending the received data from the telematics unit to an engineering monitoring station via a wireless connection.

13. The medium of claim 12, further comprising:
computer readable code for sending a user command input to the telematics unit; and
computer readable code for sending a sensor data request from the telematics unit to the sensor via a short-range wireless connection, wherein the received data is sent by the sensor responsive to the request.

14. The medium of claim 12, wherein the computer readable code for sending the received data from the telematics unit to an engineering monitoring station via a wireless connection is operable to send the received data from the telematics unit to a call center and from the call center to the engineering monitoring station.

15. The medium of claim 12, wherein the computer readable code for sending the received data from the telematics unit to an engineering monitoring station via a wireless connection is operable to send the received data from the telematics unit to a wireless local area network via a short-range wireless connection and to send the received data from the wireless local area network to the engineering monitoring station via a wireless connection.

16. The medium of claim 12, wherein the computer readable code for sending the received data from the telematics unit to an engineering monitoring station via a wireless connection is operable to send the received data from the telematics unit to a cellular network via a wireless connection and to send the received data from the cellular network to the engineering monitoring station via a wireless connection.
